(19) United States
(12) Patent Application Publication
(10) Pub. No.: US 2011/0041862 A1
(43) Pub. Date: Feb. 24, 2011

(54) Cigarette

(75) Inventors: Dietmar Volgger, Schwaz (AT); Harald Giener, Horsching (AT); Markus eibl, wels (AT); Berndt Koll, Gmunden (AT)

Correspondence Address: BAKER & DANIELS LLP, 300 NORTH MERIDIAN STREET, SUITE 2700, INDIANAPOLIS, IN, 46204, US

(73) Assignee: DELFORTGROUP AG

(21) Appl. No.: 12/866,544

(22) PCT Filed: Feb. 10, 2009
(86) PCT No.: PCT/EP09/00926

§ 371 Date: Nov. 15, 2010

(30) Foreign Application Priority Data
Feb. 14, 2008 (AT) GM94/2008

(51) Int. Cl. A24D 1/02; B05D 5/00

(52) U.S. Cl. 131/365; 427/286

(57) ABSTRACT

A cigarette, in which the paper surrounding the tobacco column comprises discrete areas, in particular in the form of bands, which are loaded with the acetate of a polysaccharide and thus increase the self-extinction of the cigarette by reducing the access of air to the burning tobacco column, wherein the polysaccharide is a starch.

The present invention refers to a cigarette in which the paper surrounding the tobacco column comprises discrete areas, in particular in the form of bands, which are loaded with the acetate of a polysaccharide and thus increase the self-extinction tendency of the cigarette by reducing the access of air to the burning tobacco column.

From U.S. Pat. No. 4,452,259 from 1984, a cigarette is known in which the combustion inhibiting areas are loaded with cellulose acetate. The combustion inhibiting effect of cellulose acetate is due to the formation of an air tight film on the surface of the paper which film either melts or encrusts upon heating. The use of this substance is of advantage in that it has no additional adverse effect on the smoker and in that it is in accordance with the pertinent regulations.

The invention is based on the search for an alternative to cellulose acetate. Surprisingly, starch acetate, which is chemically related to cellulose acetate, was found to be such an alternative. While the combustion products do not have additional adverse effects when cellulose acetate is replaced by starch acetate, it is now possible to fundamentally modify the mechanism leading to self-extinction of the cigarette. Using conventional solvents and application techniques, starch acetate can be introduced to a large extent into the paper structure with the consequence that its overall effect is due to a blocking of pores of the paper and not to a shielding effect by an external film on the paper surface. Thus, all disadvantages of such films which change the surface of the paper, not only with regard to its appearance, are avoided.

In the following, examples of preparation of a cigarette paper according to the present invention are described.

In the two following tables the most important data of ten examples (A-J) are summarized.

TABLE 1

| | | | | | |
|---|---|---|---|---|---|
| EXAMPLE | A | B | C | D | E |

Printing solution

| | | | | | | |
|---|---|---|---|---|---|---|
| Solids content | % | 13.1 | 13.0 | 11.7 | 11.7 | 12.4 |
| Ethanol:acetic acid ethyl ester | | 1:4 | 1:4 | 1:6 | 1:6 | 1:6 |
| Viscosity (flow cup DIN 4) | s | 29 | 29 | 28 | 28 | 29 |

Paper

| | | | | | | |
|---|---|---|---|---|---|---|
| Description | | Q17060 | Q15432 | Q17060 | Q15234 | Q11240 |
| Weight per unit area | g/m² | 25.5 | 22.0 | 25.5 | 22.0 | 26.0 |
| Air permeability | CU | 60 | 25 | 60 | 25 | 40 |
| Filler content | % | 27.5 | 32.0 | 27.5 | 32 | 28 |
| Pulp | | wood | wood | wood | wood | flax |
| Thickness of the paper | μm | 40.0 | 33.3 | 39.7 | 34.6 | 42.1 |

Bands

| | | | | | | |
|---|---|---|---|---|---|---|
| Width of bands | mm | 7 | 7 | 7 | 7 | 7 |
| Distance of bands (from center | mm | 25 | 25 | 25 | 25 | 25 |
| to center) | | | | | | |
| Etching depth of the impression | μm | 130 | 130 | 130 | 130 | 130 |
| cylinder | | | | | | |
| Thickness of the paper at band | μm | 40.4 | 33.9 | 40.0 | 35.1 | 42.7 |

Self-extinction

| | | | | | | |
|---|---|---|---|---|---|---|
| According to ASTM 2187-04b | % | 95.0 | 100.0 | 100.0 | 100.0 | 97.5 |

TABLE 2

| | | | | | |
|---|---|---|---|---|---|
| EXAMPLE | F | G | H | I | J |

Printing solution

| | | | | | | |
|---|---|---|---|---|---|---|
| Solids content | % | 12.4 | 11.6 | 12.5 | 12.0 | 12.3 |
| Ethanol:acetic acid ethyl ester | | 1:6 | 1:6 | 1:6 | 1:6 | 1:6 |
| Viscosity (flow cup DIN 4) | s | 29 | 25 | 28 | 28 | 28 |

Paper

| | | | | | | |
|---|---|---|---|---|---|---|
| Description | | Q17264 | Q17264 | Q11240 | Q15432 | Q17060 |
| Weight per unit area | g/m² | 26.0 | 26 | 26 | 22 | 25.5 |
| Air permeability | CU | 90 | 90 | 40 | 25 | 60 |
| Filler content | % | 26 | 26 | 28 | 32 | 27.5 |
| Pulp | | wood | wood | flax | wood | wood |
| Thickness of the paper | μm | 41.7 | 41.7 | 44.2 | 35.5 | 41.3 |

Bands

| | | | | | | |
|---|---|---|---|---|---|---|
| Width of bands | mm | 7 | 6 | 6 | 6 | 6 |
| Distance of bands (from center | mm | 25 | 25 | 25 | 25 | 25 |
| to center) | | | | | | |
| Etching depth of the impression | μm | 130 | 75 | 75 | 75 | 75 |
| cylinder | | | | | | |
| Thickness of the paper at band | μm | 42.0 | 42.0 | 44.3 | 35.7 | 41.6 |

Self-extinction

| | | | | | | |
|---|---|---|---|---|---|---|
| According to ASTM 2187-04b | % | 87.5 | 85.0 | 95.0 | 100.0 | 87.5 |

Starch acetate (highly acetylated special starch I09707-01, produced from potato starch of Agrana AG) was used as a solid in all printing solutions. The starch acetate was added to a mixture of ethanol (product number 32221, Riedel de Haen) and acetic acid ethyl ester (product number 33211, Riedel de Haen) as quickly as possible, followed by agitation in a propeller mixer for 30 minutes at 2,800 rpm.

The papers come from the present applicant and cover a typical spectrum of frequently used cigarette papers.

The application of the material to the paper is carried out by gravure printing (in a printing machine of the Cerrutti company) with a speed of about 110 m/min and drying temperatures from 60° C. to 125° C. The impression cylinders were chemically etched.

The cigarettes thus manufactured from the papers were tested according to the test procedure ASTM 2187-04b “Ignition Strength Test”. In this test, a smouldering cigarette is placed on ten layers of a filter paper, and it is determined whether the cigarette self-extinguishes on this substrate. In each example, 40 cigarettes were tested.

The thickness of the papers in the printed and non-printed zones differs on average by just 0.45 μm in examples A-F and by just 0.22 μm in examples G-J, leading to the conclusion that the predominant part of the applied material in fact permeated the paper structure and does not remain on the surface as a film, since otherwise the increase in thickness would amount to at least 4 μm taking into consideration the applied amount of material.

Examples A-J show that the self-extinction tendency is high even when the weight per unit area, the air permeability of the paper, the content of the filler, the type of cellulose as well as the width of the printed zones are modified.

1. A cigarette, wherein the paper surrounding the tobacco column comprises discrete areas, in particular in the form of bands, which are loaded with an acetate of a polysaccharide and thus increase the self-extinction tendency of the cigarette by reducing the access of air to the burning tobacco column, characterized in that the polysaccharide is a starch.

2. Method of producing a cigarette paper for manufacturing a cigarette according to claim 1, characterized in that starch acetate, dissolved in a mixture of ethanol and ethyl acetate, is applied to the paper such that it permeates the paper structure at least for the predominant part.
